(19) United States
(12) Patent Application Publication
(10) Pub. No.: US 2026/0307267 A1
(43) Pub. Date: Oct. 8, 2026

(54) VISION-GUIDED ROBOTICS FOR IN-LINE MUSHROOM PACKAGING AND WEIGHT DETERMINATION AND CONTROL

(71) Applicant: University of Maryland, College Park, College Park, MD (US)

(72) Inventors: Yang TAO, North Potomac, MD (US); Mohamed Amr ALI, Lanham, MD (US)

(21) Appl. No.: 19/638,417

(22) Filed: Apr. 3, 2026

Related U.S. Application Data
(60) Provisional application No. 63/782,770, filed on Apr. 3, 2025.

(51) Int. Cl. B25J 11/00; B25J 19/02; B65G 43/08; G01G 15/02

(52) U.S. Cl. CPC B25J 11/0045; B25J 19/022; B25J 19/023; B65G 43/08; G01G 15/02; B65G 2201/0202

(57) ABSTRACT

A system for inline vision-guided robotics includes an infeed conveyor with a line scan camera to capture image and depth data, a check weight conveyor to weigh produce containers in motion, and a robot that adjusts speed and path based on produce size and orientation. A processor with memory executes instructions to: capture image and depth data; weigh containers in motion; detect over or underweight conditions; classify produce orientation using a trained instance segmentation model; determine target pick points based on classification, produce geometry, and depth data; and direct the robot to pick or place produce into a weighted buffer queue to meet target weights based on container conditions and classified produce.

### CROSS-REFERENCE TO RELATED APPLICATION

This application claims the benefit of and priority to U.S. Provisional Patent Application No. 63/782,770, filed Apr. 3, 2025, the entire content of which (including its appendices) is incorporated by reference herein.

### GOVERNMENT SUPPORT

This invention was made with government support under 20215118135859 awarded by the National Institute of Food and Agriculture. The government has certain rights in the invention.

### TECHNICAL FIELD

The subject matter of the present disclosure relates generally to automated packaging systems and methods. More particularly, the subject matter of the present disclosure relates to vision-guided robotic systems for precision weight-based packaging of delicate agricultural products.

### BACKGROUND

Conventional methods for packaging white button mushrooms rely heavily on manual labor due to the mushrooms' fragility and inconsistent density. These approaches are time-consuming, error-prone, and often lead to overfilled packages and product waste. There is a growing need for automated solutions that can efficiently handle delicate produce while maintaining high accuracy in weight distribution. Existing automation technologies lack the precision and adaptability required for such tasks. Therefore, an improved system is needed to streamline the packaging process, reduce labor dependency, and enhance operational efficiency in the mushroom industry.

### SUMMARY

In accordance with aspects of the disclosure, a system for inline vision-guided robotics includes: an infeed conveyor including a line scan camera configured to capture image data and depth data; check weight conveyor configured to weigh a produce container in motion; a high-speed robot configured to adapt movement speed and path in real-time based on produce size and orientation; a processor; and a memory, including instructions, which when executed by the processor, cause the system to: capture image data and depth data of the produce container on the infeed conveyor; weigh the produce container in motion on the check weight conveyor; identify over or underweight conditions for the produce container based on the weight of the produce container; classify produce orientation of produce in the produce container based on image data and depth data using a trained instance segmentation model based on image data and depth data; determine target pick points based on the classification, geometric characteristics of the produce, and the depth data; and select, using the high-speed robot, produce from or placing produce into a weighted buffer queue meet target weights based on the over or underweight conditions of the produce container and the classified produce.

In an aspect of the present disclosure, the high-speed robot may further include: an end effector configured for delicate produce handling, the end effector including: a suction cup with a long stroke made from food-safe, metal-detectable material; an integrated vacuum generator; and a solenoid-controlled pneumatic line configured to toggle between suction and blow-off modes.

In another aspect of the present disclosure, the weighted buffer queue may include: a grid comprising a plurality of cells, each configured to hold a single item; a weighing system configured to measure weight changes upon placement or removal of items in the grid; and a mapping module configured to correlate each grid cell with a known spatial coordinate.

In a further aspect of the present disclosure, the instructions, when executed, may further cause the system to: store excess items not required for a current package; track the weight of stored items individually; and enable selection of an item from the buffer based on a desired package target weight.

In yet a further aspect of the present disclosure, the instructions, when executed, may further cause the system to: trigger image capture based on an incremental encoder connected to a gearbox of the infeed conveyor, the encoder configured to generate a signal indicating a position of the produce container; detect the produce container based on the captured image; and monitor the position of the produce container based on the encoder signal.

In accordance with aspects of the disclosure, the system may further include: a photoelectric sensor mounted between the infeed conveyor and check weight conveyor sections to generate a signal configured to ensure separation between incoming produce containers.

In an aspect of the present disclosure, the instructions, when executed, may further cause the system to: trigger, based on a signal of the photoelectric sensor, recording weighing information on the check weight conveyor.

In another aspect of the present disclosure, the line scan camera may be configured to capture depth information using a projected laser line to generate the depth map.

In an aspect of the present disclosure, the line scan camera may use triangulation-based laser profiling.

In another aspect of the present disclosure, the depth image may be obtained by measuring deformation of a laser line projected across a surface of the produce container.

An aspect of the present disclosure provides a method for inline vision-guided robotics including: capturing image data and depth data of a produce in a produce container on an infeed conveyor, the infeed conveyor including a line scan camera configured to capture image data and depth data; weighing the produce container in motion on a check weight conveyor; identifying over or underweight conditions for the produce container based on the weight of the produce container; classifying produce orientation of the produce in the produce container based on image data and depth data using a trained instance segmentation model based on image data and depth data; determining target pick points based on the classification, geometric characteristics of the produce, and the depth data; and selecting, by a high-speed robot, produce from or placing produce into a static, known-weight buffer queue to meet target weights based on the over or underweight conditions of the produce container and the classified produce.

In a further aspect of the present disclosure, the high-speed robot may include an end effector configured for delicate produce handling, the end effector including: a suction cup with a long stroke made from food-safe, metal-detectable material; an integrated vacuum generator; and a solenoid-controlled pneumatic line configured to toggle between suction and blow-off modes.

In yet a further aspect of the present disclosure, the weighted buffer queue may include: a grid comprising a plurality of cells, each configured to hold a single item; a weighing system configured to measure weight changes upon placement or removal of items in the grid; and a mapping module configured to correlate each grid cell with a known spatial coordinate.

In accordance with aspects of the disclosure, the method may further include storing excess items not required for a current package; tracking the weight of stored items individually; and enabling selection of an item from the buffer based on a desired package target weight.

In an aspect of the present disclosure, the method may further include: triggering image capture based on an incremental encoder connected to a gearbox of the infeed conveyor, the encoder configured to generate a signal indicating a position of the produce container; detecting the produce container based on the captured image; and monitoring the position of the produce container based on the encoder signal.

In another aspect of the present disclosure, the method may further include: generating a signal configured to ensure separation between incoming produce containers by a photoelectric sensor mounted between the infeed conveyor and check weight conveyor sections.

In a further aspect of the present disclosure, the method may further include: triggering, based on a signal of the photoelectric sensor, recording weighing information on the check weight conveyor.

In yet a further aspect of the present disclosure, the line scan camera is configured to capture depth information using a projected laser line to generate the depth map.

In accordance with aspects of the disclosure, the line scan camera uses triangulation-based laser profiling.

In another aspect of the present disclosure, the depth image is obtained by measuring deformation of a laser line projected across a surface of the produce container.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary system for inline vision-guided robotics, in accordance with examples of the present disclosure;

FIG. 2 is a block diagram of a controller for the system of FIG. 1 in accordance with aspects of the present disclosure;

FIG. 3 is view of the system of FIG. 1 without a frame around a robot, in accordance with examples of the present disclosure;

FIG. 4A illustrates a schematic of the electro-pneumatic system of the system of FIG. 1, in accordance with examples of the present disclosure;

FIG. 4B shows an overview of the system architecture and hardware-software communication protocols, in accordance with examples of the present disclosure;

FIG. 5 is a schematic diagram illustrating the communication network and protocol integration between system components, in accordance with examples of the present disclosure;

FIG. 6 is a schematic diagram of the vision-based instance segmentation and orientation classification pipeline, in accordance with examples of the present disclosure;

FIG. 7A is a timeline showing the segmented motion sequence of the robot during mushroom weight optimization tasks, in accordance with examples of the present disclosure;

FIG. 7B is a synchronized timeline illustrating the interaction between perception, weighing, and robotic manipulation systems, in accordance with examples of the present disclosure;

FIGS. 8A-8J are histograms showing the distribution of mushroom characteristics on day 1 of the characterization study, in accordance with examples of the present disclosure;

FIG. 9 presents regression plots illustrating the correlation between visual mushroom features and weight, in accordance with examples of the present disclosure;

FIGS. 10A and 10B show example prediction masks generated by the computer vision model overlaid on a depth map of a mushroom till, in accordance with examples of the present disclosure;

FIG. 11 is a diagram from a photograph of the implemented system prototype configured for inline mushroom packaging and weight optimization, in accordance with examples of the present disclosure;

FIG. 12 is a chart comparing the success rate of mushroom handling across suction cup sizes, in accordance with examples of the present disclosure;

FIG. 13 is a heatmap showing the effect of suction duration and approach height on pick success rate by mushroom size and orientation, in accordance with examples of the present disclosure;

FIG. 14 is a chart showing the success rate of mushroom handling at different robot speeds by mushroom size, in accordance with examples of the present disclosure;

FIG. 15 shows a bimodal histogram representing the task duration distribution for mushroom weight optimization, in accordance with examples of the present disclosure; and

FIG. 16 is a graph showing the change in weight distribution of the offline mushroom queue over time during full-task operation, in accordance with examples of the present disclosure.

### DETAILED DESCRIPTION

The present disclosure relates generally to automated packaging systems and methods. More particularly, the subject matter of the present disclosure relates to vision-guided robotic systems for precision weight-based packaging of delicate agricultural products.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

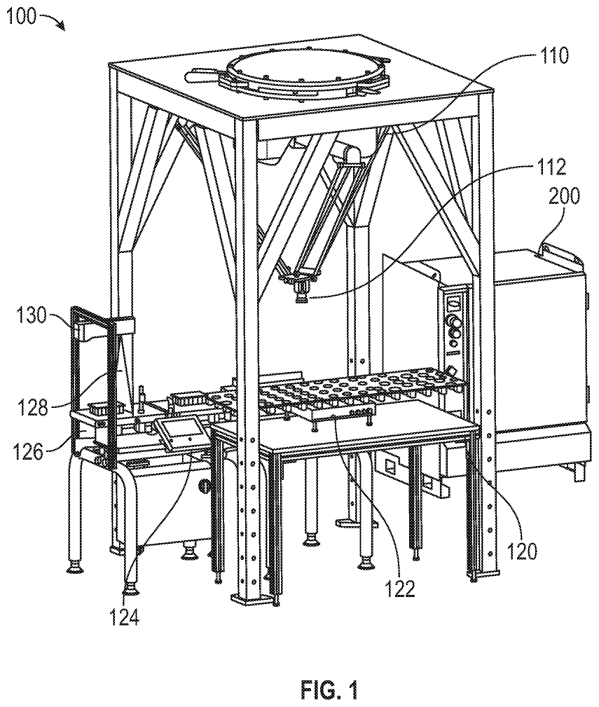

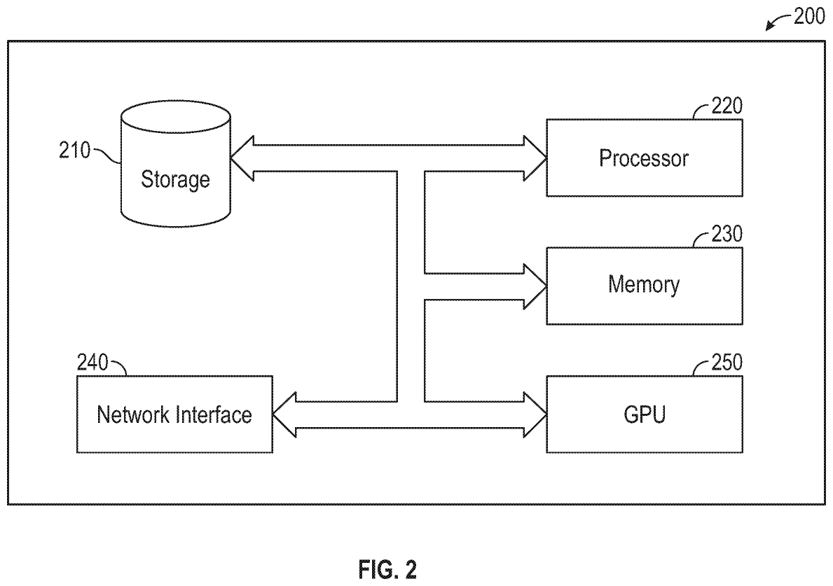

Referring to FIGS. 1-3, a system 100 for inline vision-guided robotics is shown. System 100 generally includes a check weight conveyor 124, an infeed conveyor 126, a line scan camera 130, a high-speed delta robot 110 (FIG. 2), and an offline weighted buffer queue 120. Mushroom tills (e.g., a produce container) are placed on a conveyor belt 124 with three sections: infeed (infeed conveyor 126), weighing (check weight conveyor 124), and outfeed. Above the infeed section, a line scan camera 130 is mounted for image acquisition and depth map reconstruction. The line scan camera 130 is hardware triggered using an incremental encoder connected to the conveyor's gearbox. The line scan camera 130 automatically detects tills, and the encoder signal monitors the position throughout the working space. A photoelectric sensor is mounted between the infeed and weighing sections to ensure separation between incoming tills. The photoelectric sensor also acts as a trigger signal to start recording weighing information on the check weigher conveyor 124 section. The check weigher conveyor 124 weighs tills in motion with about 0.1-gram resolution. The outfeed section of the conveyor extends within the robot workspace for mushroom processing.

System 100 operates as a closed loop sequence controlled by controller 200 using a till state machine that includes an infeed imaging state, a weigh in motion state, a manipulation eligibility state, a pick and place state, and a completion state. In the infeed imaging state, line scan camera 130 acquires an intensity image and a depth map for a produce container while an encoder position is sampled to associate each image line with a conveyor displacement. In the weigh in motion state, check weight conveyor 124 outputs a time series of weight samples for the produce container while the same encoder position is sampled to associate each weight sample with a conveyor displacement. In the manipulation eligibility state, controller 200 determines a container gross weight estimate by applying a motion filtering routine to the weight sample time series and by rejecting samples outside a stable belt contact window identified by photoelectric sensor gating. In the pick and place state, controller 200 computes a weight error relative to a target package weight, selects at least one candidate item for removal or addition, computes robot targets in a robot coordinate frame, and commands robot 110 to execute a tracked motion plan synchronized to conveyor displacement. In the completion state, controller 200 records an audit log entry that includes the final weight error, selected items, robot targets, and a success or failure status for the produce container.

Controller 200 determines a mapping from image coordinates to conveyor coordinates and from conveyor coordinates to robot coordinates using a calibration routine that includes a camera intrinsic calibration, a laser plane calibration for depth reconstruction, and a hand eye calibration between line scan camera 130 and robot 110. The camera intrinsic calibration estimates a line scan pixel to ray mapping and a depth scale factor based on a calibration target translated through known heights. The laser plane calibration estimates a laser plane equation in a camera frame using a planar target at multiple heights, enabling triangulation-based reconstruction of the depth map from a measured laser line deformation. The hand eye calibration determines a rigid transform between a camera frame and a robot base frame using a fiducial grid placed on conveyor belt 124 and sampled by both line scan camera 130 and robot 110. Controller 200 aligns time bases by timestamping encoder ticks, image line acquisition, and scale samples within a shared clock domain, enabling controller 200 to compute a predicted produce container pose in the robot workspace at a future time and to generate a conveyor tracked robot target.

Depth map reconstruction may be performed using a calibrated laser triangulation model. A laser emitter projects a structured line 128 onto a surface of the produce container at a known incident angle relative to an optical axis of line scan camera 130. For each acquired scan line, controller 200 detects a subpixel location of the reflected laser peak intensity along a sensor row using a centroid or Gaussian fitting routine. The displacement of the detected laser peak from a reference position corresponding to a known calibration plane is converted into a height value using a triangulation equation derived from the baseline distance between the laser emitter and the camera lens, the projection angle of the laser plane, and the camera intrinsic parameters. Successive scan lines acquired as the conveyor advances are concatenated using encoder indexed displacement to form a metrically scaled depth map in which each pixel represents a height value relative to the conveyor belt reference plane.

This system solves the technical problem of inaccurate and labor-intensive packaging of delicate produce, such as mushrooms, due to variability in shape, weight, and fragility. It provides the technical solution of a vision-guided robotic system with real-time weight optimization, combining depth-based instance segmentation, dynamic end-effector control, and an offline weighted buffer queue to precisely select and handle individual mushrooms without damage. Although mushrooms are used as an example, this system is applicable towards any produce.

System 100 supports additional produce categories by parameterizing perception, end effector actuation, and weight optimization using produce profiles stored in database 210. A produce profile includes a target weight, a permissible weight tolerance band, a maximum allowable contact pressure, a suction cup diameter selection, a vacuum pressure setpoint, a suction duration, a blow off duration, and a perception model identifier. For a new produce category, controller 200 obtains a training dataset that includes synchronized intensity and depth samples and labels for instances and orientation classes relevant to the produce category, trains an instance segmentation model using the same concatenated channel input structure, and validates model performance against a minimum precision threshold for safe robotic picking. Controller 200 updates an end effector parameter table by running a short commissioning routine that sweeps suction duration and approach height while measuring pick success and visible damage metrics, enabling selection of operating parameters that satisfy the maximum allowable contact pressure and a minimum pick success threshold.

High-speed manipulation is achieved using an ABB IRB 360-8/1130 delta robot. The robot controller has a Conveyor Tracking Module, which connects to the photoelectric sensor to serve as a synchronization switch. It also links to the incremental encoder to coordinate robot motion with the conveyor belt. These inputs aid the robot controller in solving inverse kinematics and planning motion trajectories for continuously moving objects. Although the robot has 4 degrees of freedom, in practice, only 3 are used in the mushroom weight optimization task. Irrespective of the mushrooms' orientation, the robot directly accesses mushroom tills from above.

The design of the end effector is critical for the system as it acts as the primary interface with mushrooms. It must be lightweight to prevent increasing the robot's load and cycle time, yet delicate enough to handle mushrooms without causing marks or discoloration. To maintain a secure hold and prevent drops during high-speed movements and accelerations, the design omits sensors and electronics at the tooltip to reduce complexity and weight, enhancing durability. Traditional gripping methods are impractical due to the close packing of mushrooms, leading to the adoption of vacuum suction for pick-and-place tasks. An electro-pneumatic system has been developed to provide high-flow vacuum suction and a positive pressure blow-off mechanism, ensuring rapid release and preventing smaller mushrooms from lodging in the suction cup.

A technical problem exists in automated packaging lines for delicate, irregular produce because in motion containers exhibit variable fill weight and variable produce geometry, while conventional automation lacks reliable perception and timing alignment to pick individual items without damage and lacks a fast mechanism to correct container weight to a target value without repeated manual style trial and error. A further technical problem exists because vision only estimates size and orientation but cannot reliably infer mass for biological produce with density variation, creating error when a packaging line attempts to meet a target weight using only visual inference.

System 100 provides the technical solution of an integrated inline packaging apparatus that synchronizes encoder triggered line scan imaging and depth reconstruction with in motion check-weighing to compute a real time container weight error, applies a trained instance segmentation model to combined intensity and depth data to identify individual produce instances and orientation, converts image space target points into robot coordinates using a calibrated transform and conveyor tracking, and actuates a vacuum based end effector with controlled suction and blow off to remove or add selected produce items. System 100 further provides a static weighted buffer queue with known cell coordinates and individually measured item weights, enabling controller 200 to select a specific addition or removal item that minimizes residual weight error within a defined tolerance band while satisfying time constraints imposed by conveyor motion, thereby achieving precise weight control without relying on visual mass estimation alone.

This technical solution improves the machine by increasing weight accuracy under continuous conveyor motion, reducing oscillatory or trial and error pick cycles, lowering mechanical stress caused by unnecessary robot movements, and improving throughput by enabling deterministic single step corrections based on measured item weights. The synchronized sensing and actuation architecture enhances positional accuracy for moving targets, reduces pick failures associated with misalignment, and decreases produce damage by tailoring suction force, approach height, and robot speed to classified size and orientation, thereby improving overall system reliability, repeatability, and operational efficiency.

Referring now to FIG. 2, exemplary components in the controller 200 in accordance with aspects of the present disclosure include, for example, a database 210, one or more processors 220, at least one memory 230, and a network interface 240. In aspects, the controller 200 may include a graphical processing unit (GPU) 250, which may be used for processing machine learning models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

In various aspects, data may be stored on the controller 200, including, for example, user preferences, historical data, and/or other data. The data can be stored in the database 210 and sent via the system bus to the processor 220.

As will be described in more detail later herein, the processor 220 executes various processes based on instructions that can be stored in the server memory 230 and utilizing the data from the database 210. With reference also to FIG. 1, a request from a user device, such as a mobile device or a user computer, can be communicated to the server through the server's network interface 240. The illustration of FIG. 2 is exemplary, and persons skilled in the art will be understood other components that may exist in a controller 200. Such other components are not illustrated in FIG. 2 for clarity of illustration.

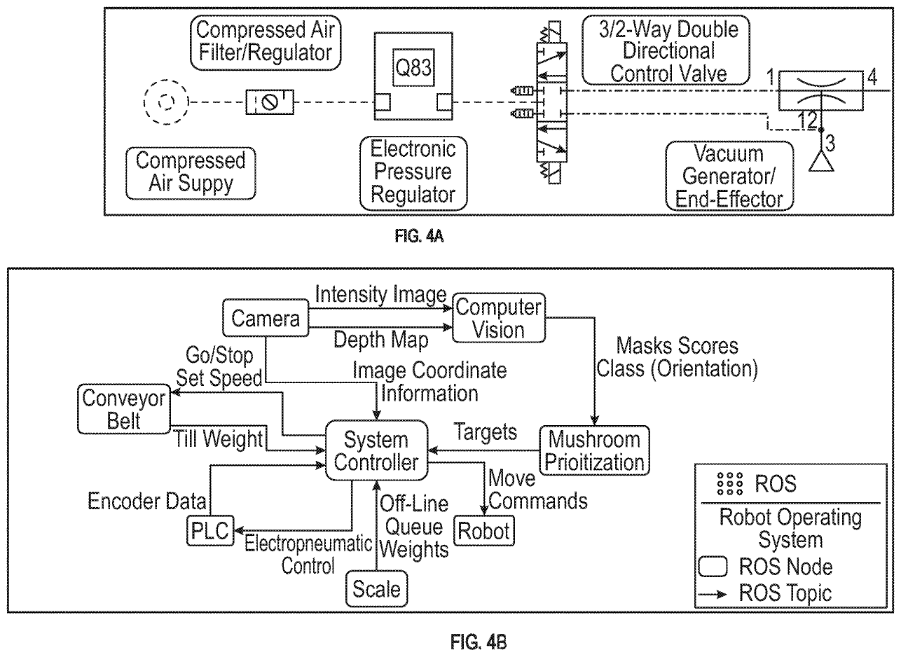

FIG. 4A shows a schematic of the electro-pneumatic system. The system is powered by two fifteen-horse oilless air compressors and is equipped with a heatless desiccant dryer. The compressed air (100 PSI) goes through a filter, regulator, and manual valve. A smaller 10-gallon air reserve tank is placed near the robot for on-demand system load. An electronic high-flow pressure control valve is connected to the reserve tank output to control the air pressure quickly and accurately. The pneumatic air is relayed to two 3/2-way (normally closed) solenoid valves to control the activation of two lines. The first line activates the vacuum suction, and the second line activates the blow-off functionality. Both lines are connected to an end effector with a built-in vacuum generator. The end effector has an attached suction cup with a long stroke (6.5 mm). The suction cup, fabricated from food-safe silicone embedded with metal chips, is specially designed to be detected by downstream metal detectors as it wears out. A Programmable Logic Controller (PLC) (see FIG. 4B) controls the pressure control valve to determine the target pressure and the solenoid valves to choose whether the end effector vacuums or blows off air. This system utilizes a positive compressed air supply sourced from a compressor, which is then filtered and regulated to ensure quality and consistency. Control valves, activated by solenoids, manage the airflow, allowing the system to generate a vacuum or release blowout air at the end effector tip, facilitating precise manipulation of mushrooms by the end effector.

The last component of the system 100 is an offline queue comprised of a grid (e.g., a 5×15 grid), as shown in FIGS. 1 and 2, where each cell holds a single mushroom. The queue position is static; therefore, each grid position is always known in the robot coordinate frame. The grid and mushrooms are continuously weighed by scale 122; subtracting the weight before and after mushroom addition can determine the weight of the added mushroom. The queue gives the central controller information to update a virtual buffer where optimization processes are computed. The queue is continuously monitored to determine if it represents a normal distribution of mushrooms. When the distribution of mushrooms in the queue is significantly skewed, the system is corrected manually by adding the necessary mushrooms to correct the distribution.

Controller 200 maintains a buffer inventory table that stores, for each grid cell, a cell identifier, a robot coordinate, an occupancy flag, an item weight, and an item class label that may include size class and orientation class. The item weight for a newly placed item is determined from a difference between a grid scale reading immediately before placement and a grid scale reading immediately after placement, with readings captured during a settled interval verified by a scale stability threshold. For an overweight produce container, controller 200 selects a removal item by minimizing an objective function that penalizes damage risk and residual overweight error, where damage risk is increased for sideways and stalk up classes and for top surface curvature below a suction sealing threshold. For an underweight produce container, controller 200 selects an addition item by minimizing an absolute residual error between a required add mass and an available buffer item weight, subject to a constraint that a selected buffer cell is reachable by robot 110 within a time budget determined from conveyor tracking. When a multi-item adjustment is required, controller 200 executes an iterative selection routine that updates a residual mass after each addition or removal and terminates on a residual mass within a tolerance band or on exhaustion of reachable candidates.

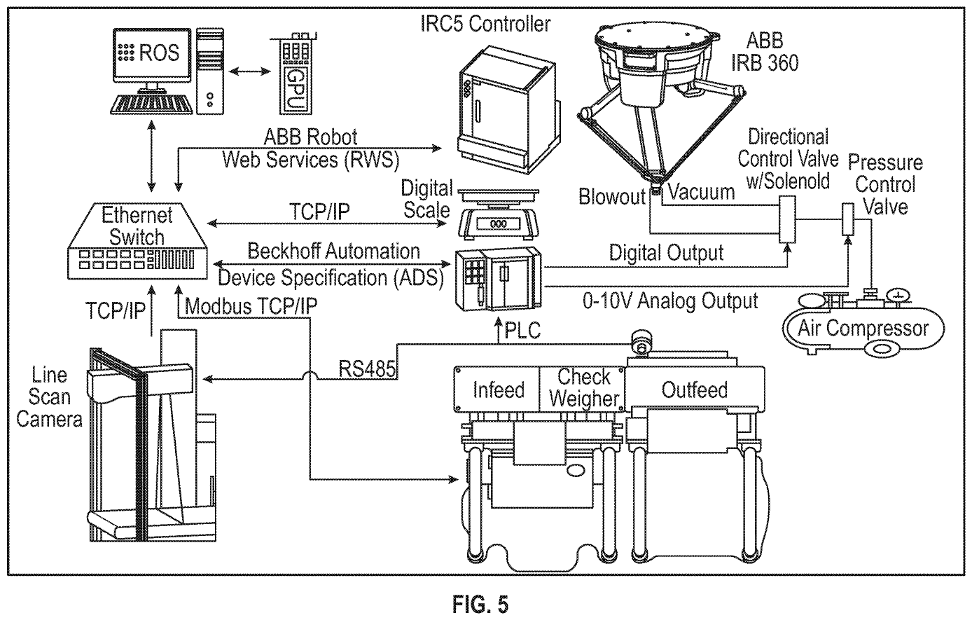

The system software is integrated into the Robot Operating System, a middleware for robotic applications. The framework contains eight executables, as shown in FIG. 4B, that communicate with each other over internal channels called topics. Each executable file uses the corresponding specialized industrial communication protocol to relay information to the respective hardware over ethernet cables. The software strategy creates a multi-tier system with PLCs and other peripheries' controllers performing real-time low-level operations, and the central controller (equipped with GPU) performs high-level abstracted decision-making procedures. High-level procedures such as computer vision are not time-critical and do not need low latencies. In the proposed implementation presented here, FIG. 5 displays the communication scheme with 1) the conveyor belt controller using Modbus/IP, 2) the line scan camera 130 and offline queue weighing system using TCP/IP, 3) the robot using Robot Web Services (RWS), and 4) the PLC using Automation Device Specification (ADS).

The Robot Operating System (ROS) utilizes nodes and topics to enable communication between different executables within the robotic framework. Each node has specific software modules that adhere to the appropriate protocols necessary for communicating with the hardware of peripheral devices. This structured communication system ensures seamless interaction and coordination between various components of the robot's operational architecture, enhancing overall system performance and reliability.

Referring to FIG. 5, a communication scheme overview is shown. The central controller 200 (FIG. 2), equipped with a GPU, uses an ethernet port to manage communications across the system. The controller 200 connects with devices using TCP/IP for the line scan camera 130 and a scale 122, Robot Web Services (RWS) for robot interaction, Beckhoff's Automated Device System (ADS) for the PLC, and Modbus TCP/IP for the conveyor belt. Low-level operations are handled via PLC's digital and analog signals.

The system 100 may be used for instance segmentation and pose estimation of white button mushrooms.

For example, a custom-made dataset is generated by imaging about 20 pounds of white button mushroom and obtaining about 1000 till images. Each till has randomly sized mushrooms placed in random orientations and form various heights. Segment Anything Model is utilized with manual prompting to annotate individual mushroom instances visible in the grayscale images. Three classes are chosen based on mushrooms' orientation: Cap-up, Stalk-up, or Sideways. The cap-up orientation category is determined by the mushroom circularity in the intensity image and the spherical feature in the depth map. The stalk-up orientation has the gills and stalk visible, facing upward. The sideways orientation is observed when the mushroom has part of the stalk laying horizontally (in any direction), and the proportion of cap height and width forms an ellipse. It is important to note that identifying sideways orientations poses a challenge, particularly when the mushroom's stalk is not visible. This difficulty extends to human labelers, who may mistakenly classify sideways-oriented mushrooms as a cap-up orientation. Overall, the training dataset (900 images) contains 10,148 mushroom instances where 5594 instances are cap-up, 1272 are stalk-up, and 2144 are sideways orientation. There is an average of 9 instances per till image. The dataset is built to maximize variation in mushroom sizes, orientation, and heights (some tills are half-filled, while others are overfilled), with mud on the mushrooms and variable stalk heights for stalk-up orientations. The validation dataset (100 images) contains 1138 instances, where 624 are cap-up, 165 are stalk-up, and 349 are sideways orientation.

The intensity image and depth map are concatenated to form the input to the Mask2former algorithm, for instance segmentation and class prediction. The network is trained using ResNet-50 and Shifted Window Transformer-Large (SWIN-L) backbone. The backbone features are relayed to a multi-scale deformable attention transformer pixel decoder as they have shown better results with depth data. The resulting pixel decoder's up-sampled features have three resolution levels and are sent to one of the 9 layers of the transformer decoder. Each feature resolution is added to a sinusoidal positional embedding and a learnable scale-level embedding. The transformer decoder has a masked-attention mechanism that has masked-attention followed by self-attention. The network ground truth masks are not an entire mask but 12544 pseudorandom points within the mask, similar to the point render algorithm. The transformer decoder is trained using 30, 50, and 100 queries. The network is trained on a workstation with an Intel i9-12900KF processor and Nvidia RTX 4090 GPU. The results are reported for the top 15 instances using the COCO evaluation metrics of each network. The results also report the average duration for the model inference for 10 consecutive images.

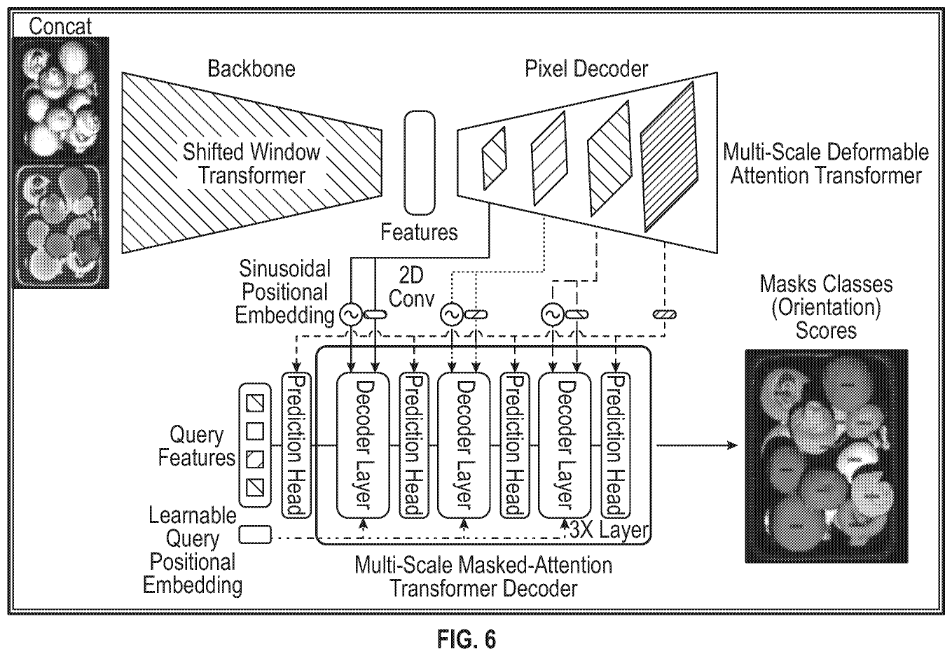

Regarding FIG. 6, a computer vision algorithm is shown. The Mask2Former framework is adeptly utilized for analyzing the concatenated channels of intensity images and depth maps from mushroom tills. This framework begins by employing a Shifted Window Transformer (SWIN) to extract features. These features are subsequently directed to a multi-scale Deformable attention pixel decoder. At each level, the pixel decoder integrates learnable scale-level embeddings with sinusoidal positional embeddings, which are then processed by a multi-scale masked-attention transformer decoder. The transformer decoder is equipped with learnable query features and positional embeddings, specifically tailored to predict mushroom orientation (class) and generate precise 2D instance masks. Additionally, the intermediate predictions generated by the transformer are utilized to compute auxiliary losses, enhancing the transformer training.

The mask predictions are post-processed based on prediction scores, class, mask size, and a prioritization scheme. First, segmentation masks with a confidence score of less than 60% are discarded. Each mask prediction is multiplied by the depth map, and the average depth for the predicted mask is calculated. The average depth masks are then sorted in descending order to obtain the topmost mushroom. Cap-up predictions are tested for circularity (threshold=0.5) to prevent multiple instances predicted as a single instinct. If the mask has multiple sections, the section with the largest area is retained. The center pixel of cap-up and stalk-up instances is marked as the centroid of the robot target. Sideway predictions' highest point in the depth map is marked as the centroid for the robot target. This strategy avoids robot targeting between the cap and stalk when the mushroom is sideways.

Controller 200 assigns an uncertainty score to each candidate pick point using a combination of segmentation confidence, mask compactness, depth continuity, and a merged instance indicator derived from multi lobe masks and circularity anomalies. When uncertainty exceeds an uncertainty threshold, controller 200 triggers a fallback routine that includes reacquisition of an additional line scan frame at a downstream encoder position, recomputation of a pick point using a multi view depth consistency check, and optional selection of an alternate candidate instance ranked by a depth based topmost criterion. When uncertainty remains above the uncertainty threshold after the fallback routine, controller 200 classifies the produce container as a bypass container and inhibits robot 110 interaction for the produce container while recording a bypass reason code, maintaining food safety and throughput without requiring manual tuning of segmentation thresholds.

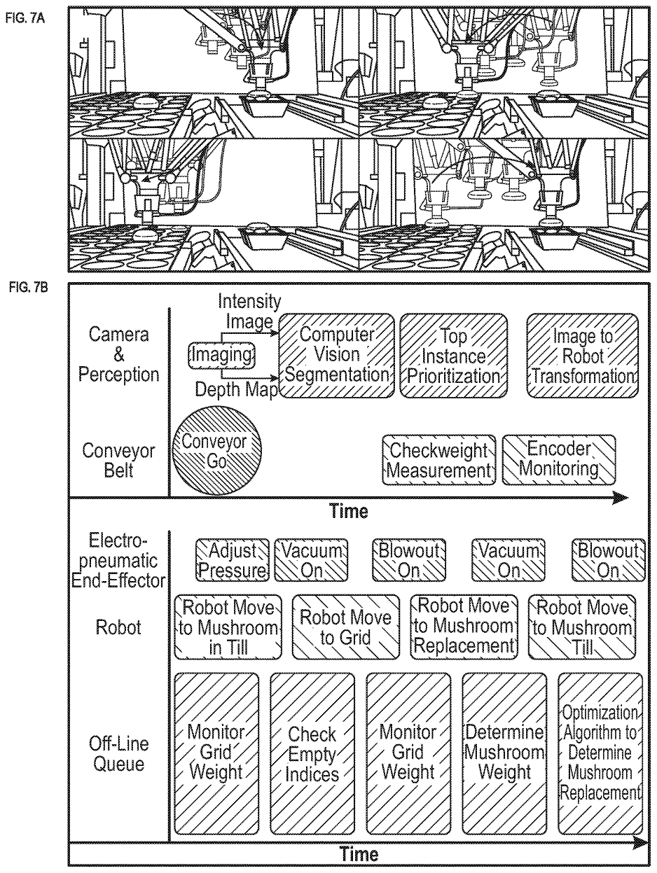

The robotic movement is divided into four major segments, each consisting of smaller intermediate steps, which facilitate fast and efficient operations (FIG. 7A). The first segment involves the robot moving towards the conveyed till, hovering above the target mushroom before descending to grasp it. This maneuver includes vertical upward and downward motions to prevent the mushroom stems from contacting adjacent mushrooms, thus avoiding adjacent mushroom movements. The second segment involves the transition from the till to the offline grid, which is carefully choreographed to include an upward arc movement. This arc mid-point is strategically implemented to prevent collisions with the conveyor side rails and offline queue. Subsequently, the robot moves between offline grid cells, where it picks and/or places mushrooms according to the sorting and optimization algorithm. The final segment entails the robot returning from the offline grid to the conveyed till. This return path mirrors the outbound journey and targets the synchronized till location from the conveyor tracking module.

FIG. 7B illustrates a comprehensive timeline showcasing the interplay between the robot's major maneuver segments and other critical system components throughout the mushroom weight optimization task. The top timeline begins with the camera perception phase, where an intensity image and a depth map are captured. These images are processed using an instance segmentation algorithm to prioritize the topmost mushroom in the till. Concurrently, the conveyor's check weight system measures the till weight. The controller monitors the encoder signal to confirm that the till has moved past the check weighing area and is positioned on the manipulation conveyor (outfeed conveyor) for mushroom removal. This step is followed by transforming the mushroom's image coordinates to robot coordinates for precise physical handling.

The bottom timeline details the robot's segment maneuvers integrated with electro-pneumatic actions. The process starts with adjusting the pressure settings and activating the vacuum for effective mushroom handling. Strategically, the robot moves mushrooms from the tills to the offline queue. This queue weight is continuously monitored, and optimization algorithms are applied to check all grid indices to identify the optimal mushroom replacement for each till. Throughout this process, blowout mechanisms are employed to expedite the deposition of mushrooms.

In brief, with reference to FIG. 7, a timing diagram overview is shown. (FIG. 7A) Illustrates the four major segments of robotic movement: moving to the till, transferring from the till to the offline buffer queue, navigating between grid cells, and returning from the offline queue to the till. (FIG. 7B) The top timeline details actions related to camera perception and conveyor belt operations, while the bottom timeline focuses on robot movement and end-effector operations, alongside interactions with the offline queue for weight optimization. Note: Timelines are illustrative and not to scale, emphasizing the sequence of actions.

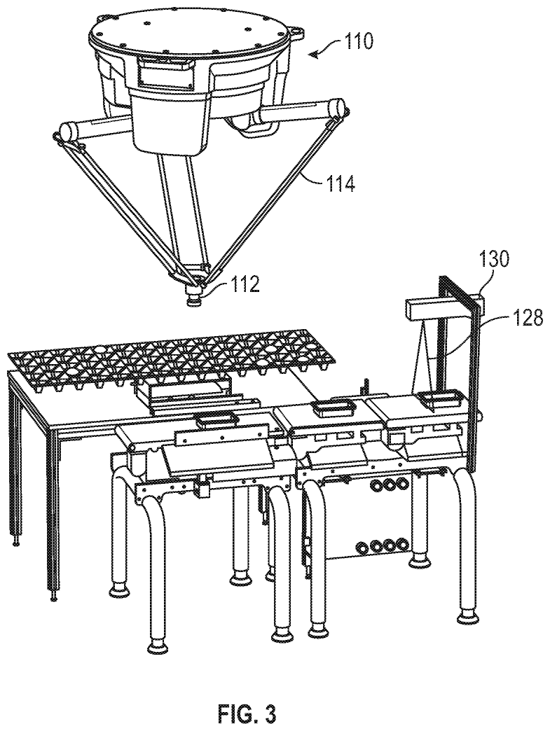

Although it is widely known that mushroom variation exists based on density and stalk size, it is necessary to understand the distribution of mushroom weights and physical sizes. White Button Mushroom is studied to determine if reliable metrics exist to predict mushroom weight based on visual size. Six mushrooms are placed in an experimental holder, as shown in FIG. 3. The experimental holder is placed on a conveyor belt with a line scan depth camera to obtain 2D-intensity (grayscale) images and depth maps. Once the experimental till is loaded, each mushroom is individually weighed. In the mushroom characterization study, 16.7 pounds (7.983 Kg) of mushrooms were purchased from eight local grocery stores to maximize variability, growers, storage humidity, and packaging sizes. Overall, 293 mushrooms are individually scanned and weighed. Segment Anything Model (Kirillov et al., 2023) is used to annotate mushrooms in the experimental tills. The resulting masks are superimposed on the depth map to obtain mushrooms' average heights. Using the intensity image, mushroom diameter (mm) and area (mm²) are obtained, and using the depth map, the average height of mushroom caps (mm) is recorded. The area multiplied by the average height estimates the cap volume (mm³). Mushrooms are stored at 4.4 degrees Celsius (40 degrees Fahrenheit) for three days, and the characterization study is repeated to determine the effects of long-term storage on mushroom size and weight.

To examine the extent to which mushroom tills are over or under filled, mushroom tills are weighed from 8 local grocery stores. In total, 45 226.8 grams (8-ounce) and 30 453.6 grams (16-ounce) tills are weighed. Each plastic till is weighed, and the mean weight of the plastic container is subtracted depending on the till size. The reported till error rates provide quantitative values to elucidate the extent of the overfilling problem after manual workers' interventions. Furthermore, the mean weight of over/underfilling provides the objective weight resolution for the proposed machine.

A series of experiments were conducted to optimize the speed and accuracy of the system. These experiments primarily focused on evaluating the end-effector's vacuum suction capability for handling mushrooms, the robot's movements, and the overall performance of the vision-guided robotic task. Each task component was meticulously examined through repeated trials to identify the most reliable combination of subtasks, ensuring that each element of the system contributes optimally to its overall effectiveness.

Mushrooms are categorized into three groups-small, medium, and large-based on their weight and area (mm²) as derived from the mushroom characterization study results. These classifications are determined using Equation 1:

$$μ \pm ( 0.44 \times σ ) \qquad ( 1 )$$

where μ is the mean of the distribution, and σ is the standard deviation. This equation applies the empirical rule to establish upper and lower boundaries for the medium group. Mushroom weights falling below the lower boundary are classified as small, while those exceeding the upper boundary are considered large. These boundaries are determined for weight (in grams) and area (in mm²) distributions, ensuring precise categorization based on quantifiable metrics.

The effectiveness of the end effector in handling mushrooms is one of the most critical aspects of the proposed system. The end effector should accommodate various sizes and orientations and handle mushrooms delicately while the robot operates at high speeds, (e.g., moving at a speed higher than 2000 mm/sec). Ultimately, it affects the system throughput, maintains the aesthetic quality of mushrooms, and ensures successful manipulation of mushrooms from one location to another. Consequently, in conjunction with robotic actions, detailed experimentation of the end effector's parameters has been undertaken to optimize its performance and reliability.

In all experiments, six mushrooms are loaded into the experimental mushroom till and conveyed to the robot workspace. The robot's Conveyor Tracking Module knows the individual mushroom's position. This setup using the experimental mushroom till is specifically designed to minimize potential confounding errors that could arise from inaccuracies in computer vision localization. Unless specified otherwise, the robot's velocity, acceleration, and trajectories remain constant across all trials. These robot trajectories are consistent with those described in the Mushroom Characterization study.

The first experiment aims to identify the optimal suction cup size for handling mushrooms effectively. This experiment utilizes suction cups of 20 mm, 30 mm, and 40 mm diameters to pick and place twelve mushrooms of each size category, e.g., small, medium, and/or large, from the experimental till to the offline queue. To assess the impact of suction cup size, trials are conducted with the suction cups positioned at 0 mm above the mushroom surface. The robot's vertical movement is set to its maximum velocity of 7000 mm/sec to simulate operational conditions. In total, 216 pick-and-place operations are attempted, and the success rate is recorded based on whether a mushroom is successfully picked up and remains secured until it is released into the offline queue.

The second experiment aims to determine the minimal time required for successful vacuum suctioning of mushrooms using a 40 mm suction cup. This experiment evaluates three suction durations: 100, 200, and 300 milliseconds. Trials are conducted across varying mushroom sizes (small, medium, large) and orientations (cap-up, stalk-up, and sideways) to ensure comprehensive results. Similar to the first experiment, the success of each trial is determined based on whether the mushroom is successfully picked up without dropping during the initial pick and subsequent robot movement. Six mushrooms are tested for each combination of size, orientation, and suction duration, resulting in a total of 162 trials.

The third experiment aims to determine the optimal height at which the robot should hover over the mushroom to achieve successful vacuum suction. This experiment builds upon the height tests conducted in the first experiment but uses a 40 mm suction cup exclusively for all trials. This suction cup features a longer stroke length of 6.5 mm, which allows for testing at negative heights relative to the mushroom surface. Trials are performed at −1 mm, 0 mm, and 1 mm above the mushroom. Consistent with the previous experiments, this task is executed across three mushroom sizes (small, medium, and large) and three orientations (cap-up, stalk-up, and sideways). A trial is deemed successful if the mushroom is picked up without causing any movement to the till, which is crucial for maintaining image registration. The failure criteria are specifically set to ensure that negative heights do not cause excessive downward movement, potentially displacing the till on the conveyor belt. Overall, 162 mushrooms are tested under these conditions.

To examine the robustness of the end effector, velocity-based experiments are conducted, similar to the previous end effector-focused tests. These experiments are designed to identify the optimal speed parameters that ensure the mushroom is consistently held without dropping. Mushrooms are picked from the experimental till at speeds of 2000, 3000, and 4000 mm/s to analyze the impact of robot velocity on mushroom handling. The robot's acceleration for each velocity setting is maximized at 100 percent. Unlike the standard pick-and-place tasks, in these trials, the robot picks the mushroom and follows a pre-defined square trajectory with side lengths of 600 mm. This movement subjects the mushrooms to intense acceleration and deceleration at each corner, testing the end effector's capacity to maintain a secure hold under dynamic conditions. Trials are deemed successful if the mushroom remains held throughout the maneuver, and failures are recorded if the mushroom is dropped. The experiment is performed on 18 mushrooms across three size categories, totaling 162 trials.

In the comprehensive evaluation of the vision-guided robotic system, the conveyor belt speed is set to 8 meters per minute to assess mushroom weight optimization across the entire packaging process. The experiment involves one hundred 453.6 grams (16-ounce) tills in a weight optimization task. The side queue is initially filled to 85% of its capacity, with changes to the mushroom side queue distribution monitored after every three tills to evaluate the system's handling efficiency.

Optimal end effector parameters derived from previous experiments are applied to this full-task scenario. Robot velocity is adjusted according to the size and orientation of the mushrooms to optimize handling and placement accuracy. The initial and final weights of each till are precisely measured using an external scale that is tared after recording each till's weight. This process allows for an accurate assessment of the percent weight improvement obtained using Equation 2:

$$\% Improvement = [ ( initial error - final error ) / initial error ] \times 100 \qquad ( 2 )$$

$$where initial error does not equal to zero .$$

Additionally, the mean duration of the full task is recorded, providing essential data on the system's maximum throughput capability. This measurement is crucial for understanding the efficiency and productivity of the robotic packaging system in a real-world operational setting.

Table 1 presents the error rates for till weights, showing that 226.8 grams (8-ounce) tills incurred an overfilling rate of 18.1 g. Meanwhile, 453.6 grams (16-ounce) tills exhibited an overfilling rate of 19.8 g. These results indicate that the lighter tills, despite their smaller nominal weights, tend to have higher proportional errors. This pattern suggests that efforts to improve accuracy should particularly focus on lighter tills as they present the potential for the most significant weight improvement. Given that the error exceeds 15 g in all cases, scales with high resolution are necessary to achieve and surpass this objective, underscoring the need for exact weighing mechanisms in the packaging process.

TABLE 1
Till target weights and corresponding overfill
weight error for 8- and 16-ounce tills.

| | Till | Till | Till | Till | |
|---|---|---|---|---|---|
| Number of | Target | Target | Mean | Weight | |
| Tills | Weight | Weight | Weight | STD | Overfill |
| Examined | (Oz.) | (g) | (g) | (g) | (g) |
| 50 | 8 | 226.8 | 244.9 | 10.1 | 18.1 |
| 30 | 16 | 453.6 | 473.4 | 17.0 | 19.8 |

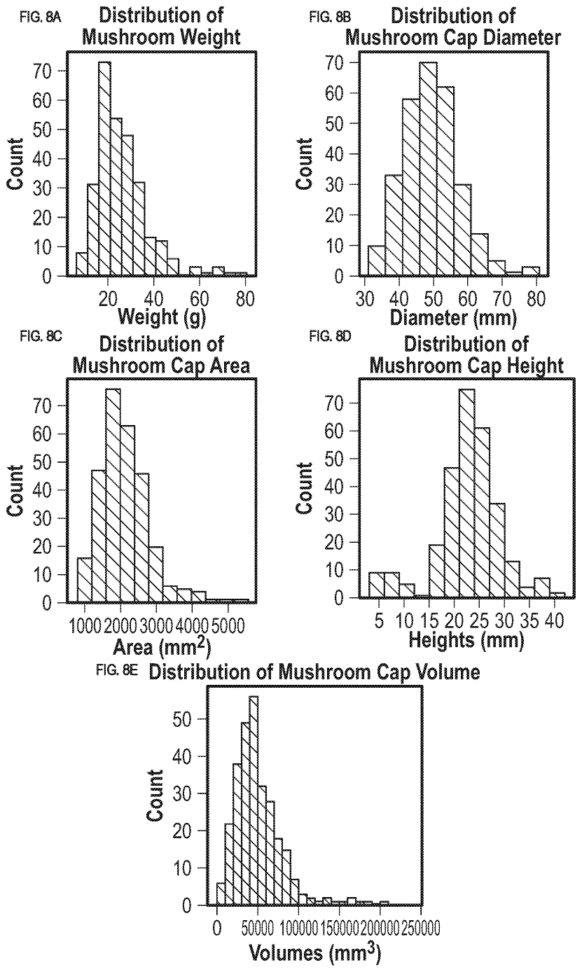

As depicted in Table 2 and FIG. 8, individual mushroom characterization results illustrate the variations in mushroom dimensions and weight throughout the study. Measurements taken on the first day and three days later include mean diameter, height, cap area, and weight. Utilizing these measurements, the mean and standard deviation were calculated to define the boundaries for mushroom categorization using Equation 1. Specifically, the lower boundary was determined to be 20.76 grams, and the higher boundary at 31.28 grams. Consequently, mushrooms weighing under 20.76 grams are classified as small, those over 31.28 grams as large, and those between these two boundaries as medium.

TABLE 2
Mushroom characterization results include the mean
and standard deviation of mushroom diameters, heights,
areas, and weights measured on day 1 and day 3.

| | Diameter | Height | Area | Weight |
|---|---|---|---|---|
| | (mm) | (mm) | (mm²) | (g) |
| Day 1 Mean | 50.6 | 22.6 | 2348.7 | 26.0 |
| Day 1 Std | 14.3 | 7.1 | 2472.9 | 12.00 |
| Day 3 Mean | 50.3 | 21.6 | 1994.9 | 24.64 |
| Day 3 Std | 8.3 | 8.8 | 628.5 | 11.41 |

FIGS. 8A-E. Distributions of Mushroom Characteristics: The histograms display the distribution of mushroom characteristics on the first day of experiments, segmented into (A) weight in 5 g bins, (B) cap diameter in 5 mm bins, (C) cap area in 400 mm² bins, (D) mean cap height in 3 mm bins, and (E) estimated cap volumes in 10,000 mm³ bins.

FIGS. 8F-J. Distributions of Mushroom Characteristics: The Histograms display the distribution of mushroom characteristics on the third day of the experiment, segmented into (F-J) with the corresponding histograms using the same bin sizes.

This categorization process divided the dataset of 293 mushrooms into 109 small mushrooms, 111 medium mushrooms, and 67 large mushrooms. The structure of the experiment and the subsequent results were based on these classifications, ensuring a rigorous analytical approach tailored to the distinct characteristics within the mushroom population.

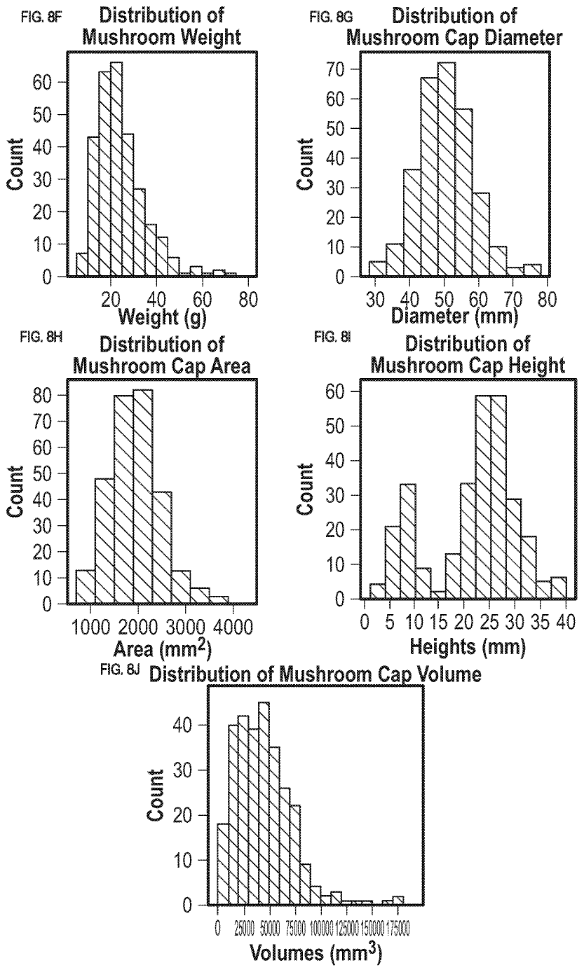

FIG. 9 presents a linear correlation between various mushroom characteristics, including diameter, area, cap height, volume, and weight. The figure includes a regression line with 95% confidence and 95% prediction intervals. While the analysis reveals a positive correlation between these dimensions and weight, the wide distribution-spanning up to 40 grams-underscores the limitations of using visual features to predict mushroom weight precisely, particularly in high-throughput industrial automation, where reliability is crucial.

Mushroom regression analysis between mushroom (A) diameter, (B) area, (C) height, (D) volume, and weight. The 95% prediction intervals, ranging from 20 to 40 grams, highlight the insufficiency for high accuracy required for mushroom weight optimization.

Despite these limitations, the visual features of mushrooms can still provide valuable insights into less critical parameters such as robotic speed, suction time, and the robot's height above the mushrooms. Thus, the data from the mushroom characterization study is instrumental in informing the approach to the full task, where optimizing throughput is a priority, and decisions regarding robot speed are tailored based on the visual characteristics of mushrooms.

### Instance Segmentation and Orientation Classification Results

Table 3 displays the COCO evaluation metrics (Lin et al., 2015) for the mushroom instance segmentation and orientation classification model. Average Precision (AP) is calculated across a range of Intersection over Union (IoU) thresholds from 0.5 to 0.95 in increments of 0.05. The AP values reported are based on all categories and primarily reflect the model's effectiveness in differentiating mushrooms from the background, thereby minimizing false positives. All AP values are reported for large items, as each mushroom exceeds 962 pixels.

TABLE 3
COCO results for mushroom instance segmentation and orientation
classification using multiple model backbone and query number.
The execution time for each model is reported.

| | | | | AP- | AP- | | Execution |
|---|---|---|---|---|---|---|---|
| Model | | | | Cap- | Stalk - | AP- | Time |
| Backbone | Queries | AP | AR100 | Up | Up | Sideways | (sec) |
| ResNet-50 | 50 | 58.34 | 72.78 | 74.19 | 59.79 | 41.04 | 0.0310 |
| SWIN-L | 20 | 61.91 | 76.07 | 76.87 | 60.61 | 48.26 | 0.0753 |
| SWIN-L | 30 | 72.13 | 84.32 | 85.23 | 74.38 | 56.79 | 0.0779 |
| SWIN-L | 50 | 62.05 | 76.28 | 75.05 | 64.39 | 46.71 | 0.0771 |

Average Recall (AR) measures the model's ability to detect mushrooms, reporting the maximum recall achievable with a fixed number of detections per image. AR values are provided for all IoUs and categories, offering a comprehensive view of detection performance. Additionally, AR100 is specifically highlighted to demonstrate the model's capacity to effectively segment up to one hundred mushrooms per image, showcasing its applicability in high-throughput scenarios.

In evaluating model backbones with varying numbers of queries, the SWIN-L backbone consistently outperformed the ResNet-50 across most metrics. With 30 queries, the SWIN-L reached a peak Average Precision (AP) of 72.13 and an Average Recall (AR100) of 84.32, significantly higher than other configurations. Specifically, the performance in recognizing cap-up orientation was notably superior, achieving an AP of 85.23.

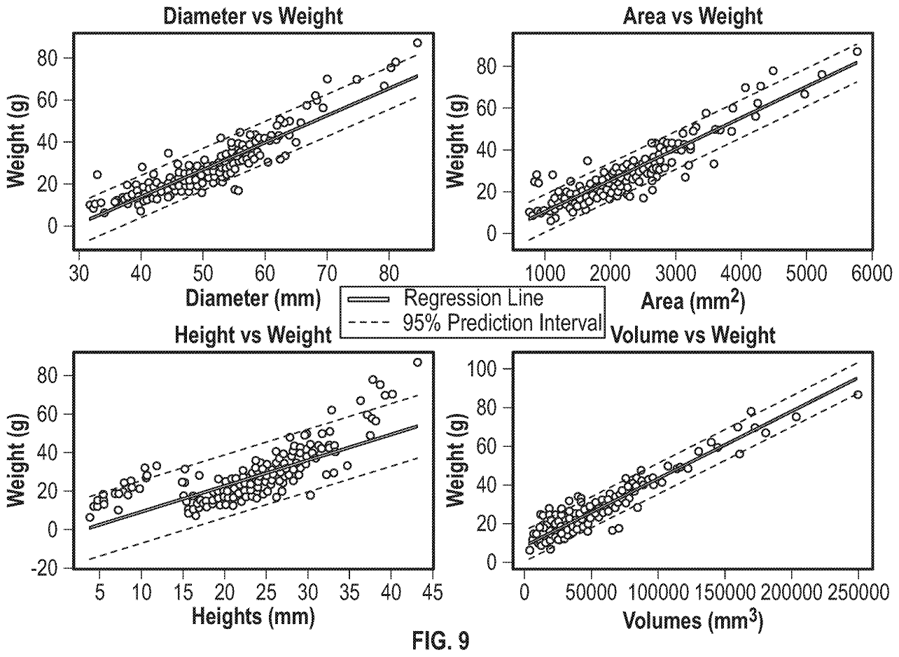

FIG. 10A illustrates an example of the computer vision prediction masks applied to each mushroom in a till. Each prediction mask includes labels for the mushroom's orientation and the model's confidence level. These masks are superimposed on the depth map to identify the topmost mushroom instance in the till. Using a prioritization scheme, informed by the depth map and prediction masks, aids in accurately determining a target point for robotic interactions, specifically, the centroid or highest point on the mushroom. This target point is visually marked with a red crosshair in the figure, highlighting its importance for precise robotic picking operations.

FIGS. 10A and 10B. Computer Vision & Mushroom Prioritization Results: (FIG. 10A) Mushroom instance segmentation and orientation classification results are previewed on the intensity image. The topmost target mushroom is marked with a red crosshair. (FIG. 10B) The prioritization scheme utilizes the depth map to determine the highest mushroom in the till.

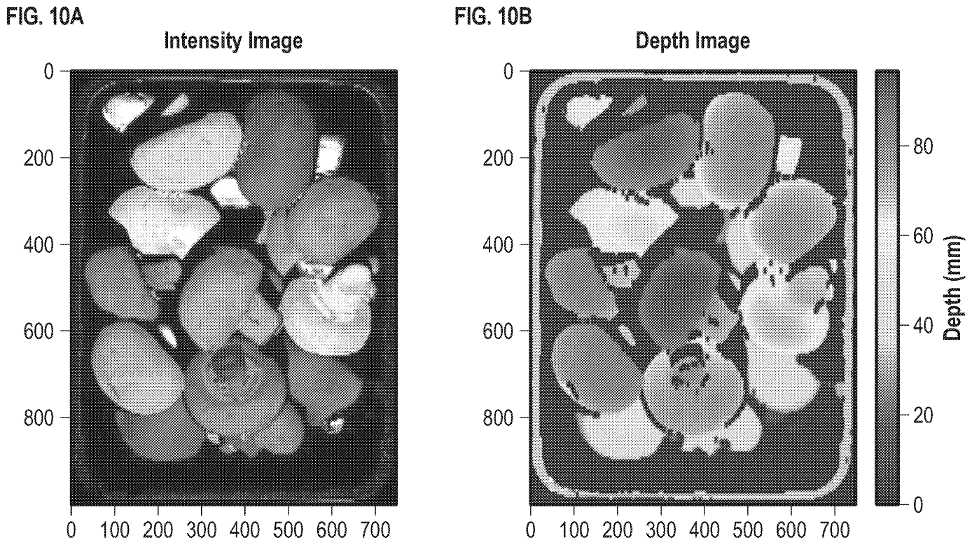

FIG. 11 is a diagram showing an actual configuration of the inline mushroom weight optimization machine from a photograph. This system is designed with a compact footprint, making it suitable for installation in small mushroom packaging plants. Constructed with a robust custom steel frame weighing half a ton, the design effectively minimizes vibrations from the robot, ensuring stability and accuracy, particularly in maintaining the integrity of the weighted offline queue. All system components are industrial grade and meet food safety standards, enabling operation in refrigerated environments essential for mushroom packaging processes.

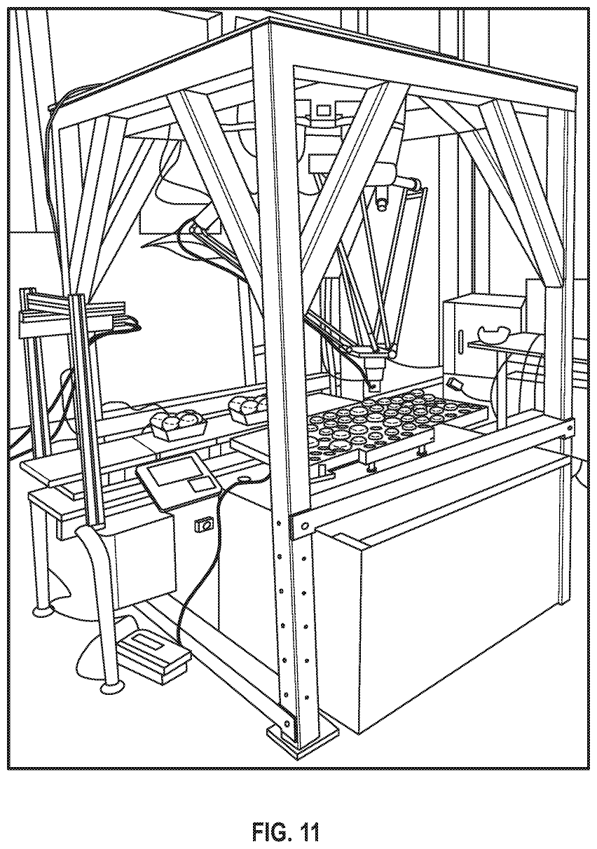

The outcomes of the suction cup size experiments are depicted in FIG. 12. The 20 mm suction cup struggles to handle large mushrooms, indicating insufficient capacity for larger sizes. As the suction cup size increases, the results improve notably, with the 40 mm cup achieving optimal performance, successfully securing 12 out of 12 mushrooms of all sizes.

FIG. 12 illustrates the handling success by suction cup size. The success rates of mushroom handling are differentiated by suction cup size categorized by mushroom size.

Given these findings, the 40 mm suction cup has been selected for use in subsequent experiments. The inferior performance of the 20 mm and 30 mm cups is logical when considering their surface areas are 314.159 mm² and 706.86 mm², respectively. Given that the average area of the mushrooms tested is 2348.7 mm², these cups cover only about 13.3% to 30% of a medium mushroom's surface area. This coverage is insufficient to create a robust vacuum, as suction force is proportional to the pressure drop and the contact surface area.

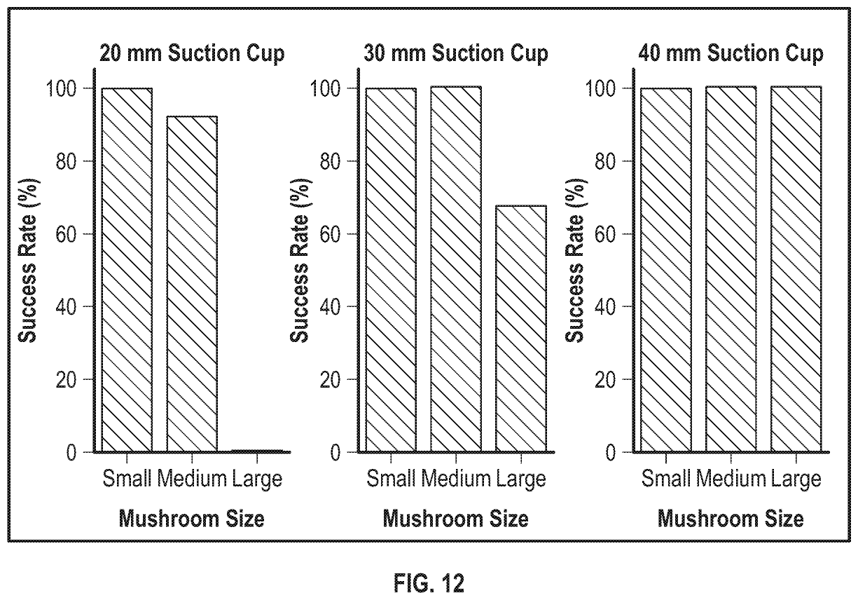

FIG. 13 presents a heat map illustrating the optimized suction time and height above mushrooms, categorized by size and orientation, based on data from the second and third experiments. The results indicate that cap-up mushrooms consistently achieve higher success rates than sideways and stalk-up orientations. This is primarily because the cap-up position minimizes air leakage, enhancing suction efficacy. The experiments also reveal that setting the robot to reach a height of −1 mm above the mushroom yields better outcomes than 0 mm or 1 mm. This improved performance is attributed to the experimental mushroom till's hard surface, which provides a stable base for effective suction. Additionally, longer suction durations, particularly 0.3 seconds, prove more effective than shorter intervals of 0.1 or 0.2 seconds, as they allow more time to establish a strong vacuum seal.

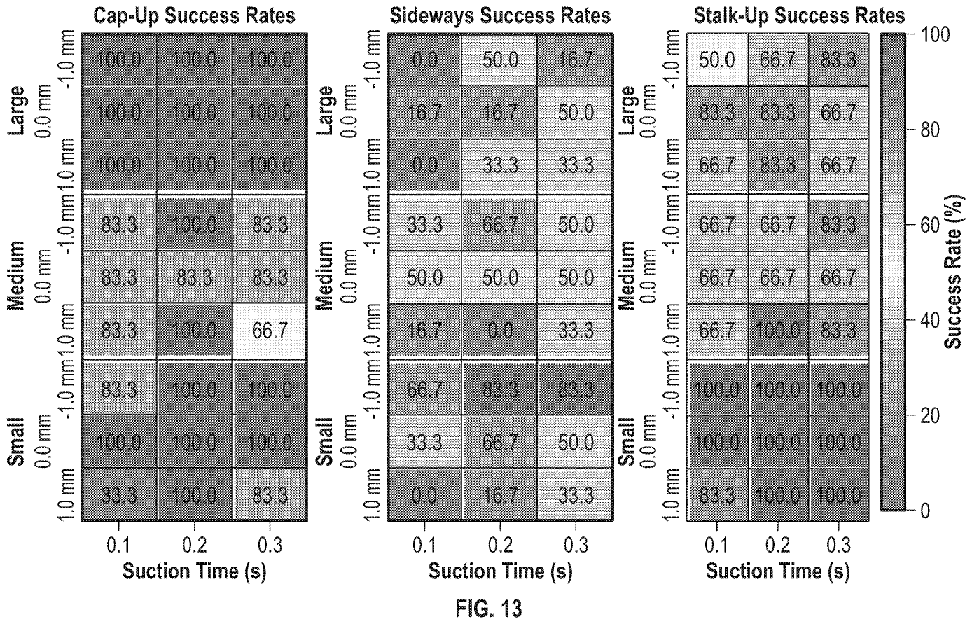

FIG. 14 delineates the outcomes of the robot velocity experiments, examining how different speeds affect the success rates of mushroom handling by size category. Robot speed does not impact the success rate for small mushrooms, which remains at 18/18 across all tested velocities. Medium mushrooms display a robust handling capacity at slower speeds but experience a slight decline in success, with one drop recorded at the highest speed of 4000 mm/sec. Success Rate of Mushroom Handling by Robot Speed and Size Category: The effectiveness of robotic handling at speeds of 2000, 3000, and 4000 mm/sec across different mushroom sizes.

Large mushrooms present a significant challenge; they maintain a moderate success rate of 14/18 at the slowest speed of 2000 mm/sec, but their ability to be securely handled declines sharply at higher speeds, plummeting to a 0/18 success rate at 4000 mm/sec. This trend, where success rates decrease with increasing speed, is attributed to the greater momentum exerted on the larger mushrooms, exacerbating handling difficulties. Given these results, the subsequent full-task experiments will implement a dynamic speed selection strategy. The approach aims to optimize the balance between maintaining high success rates and achieving efficient throughput by adapting robot speeds based on mushroom size.

The examination of one hundred 453.6 grams (16-ounce) tills revealed an initial mean overfill of 13.5 grams. Following the implementation of the mushroom till optimization process, the average error rate was significantly reduced to 1.72 grams, achieving an 87.310% improvement in accuracy, or a 7.8 times lower error than manual packaging. Table 4 displays the initial and final average till weights and their standard deviation. The substantial reduction in error demonstrates the effectiveness of the optimization strategies employed.

TABLE 4
Outcomes of the weight optimization process using the proposed vision-
guided robotic system. Displayed results are adjusted for till are.

| | Initial (g) | Final (g) |
|---|---|---|
| Till Weight (Mean) | 467.14 | 455.31 |
| Target Weight | 453.59 | 453.59 |
| Error Rate (Mean) | 13.55 | 1.72 |

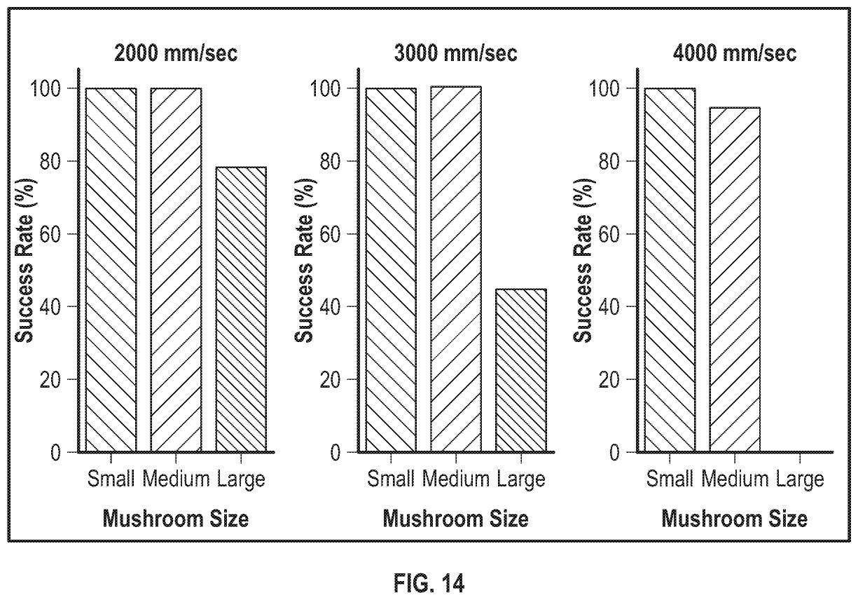

The task duration distribution, depicted in FIG. 15, exhibits a bimodal pattern, supporting the operational settings of 4000 mm/sec for handling small mushrooms and 3000 mm/sec for medium and large mushrooms. A mixed Gaussian model fitted to the duration data reveals mean values of 3.36±0.17 seconds and 6.45±0.15 seconds for the two modes, corresponding to processing rates of approximately 18 tills per minute for small mushrooms and 9 tills per minute for medium and large mushrooms. Cumulatively, the average processing rate for all one hundred 453.6 grams (16-ounce) tills is 12 tills per minute or 0.36 tons per hour. These findings underscore the efficiency of the robotic system in optimizing mushroom packaging throughput, particularly when tailored speed settings are applied according to mushroom size.

FIG. 15. Bimodal Task Duration Distribution for Mushroom Weight Optimization Task: The task duration distribution is bimodal, reflecting two distinct operational speeds of the robotic system. The first Gaussian has a mean of 3.36 seconds, associated with the faster robotic movements required for manipulating small mushrooms. The second Gaussian, with a mean of 6.45 seconds, corresponds to the slower movements for handling medium and large mushrooms. This differentiation in speeds illustrates the system's adaptive response to the varying physical characteristics of the mushrooms.

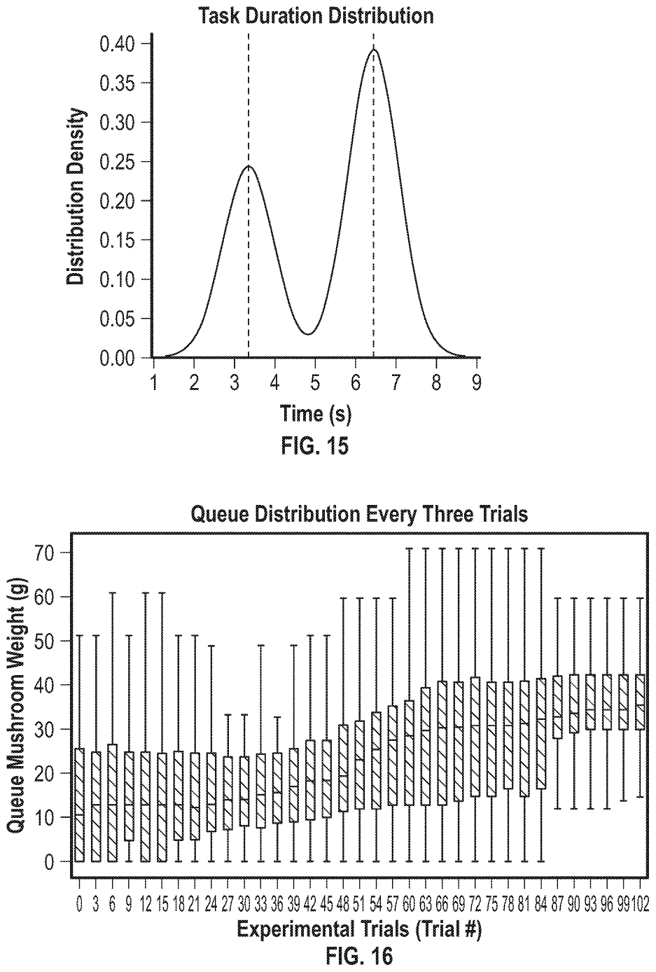

FIG. 16 provides a detailed view of the weight distribution within the side queue, monitored every three tills throughout the processing of one hundred tills. The graph shows a median weight that increases incrementally over time, suggesting a gradual weight accumulation in the side queue as the process progresses. This observation aligns with expectations that the side queue would adaptively adjust based on the operational demands of the tills. The distribution of mushroom queue weight over experimental trials was examined every three trials.

Additionally, it is noted that until trial 84, empty cells were available in the queue, as indicated by the lower boundary of the range. This availability of empty cells played a significant role in the dynamic adjustments within the queue. The interquartile range, which measures the spread of the data, exhibits variability without a distinct trend. This variability results from the dynamic nature of the side queue operations, where mushrooms are added, removed, or replaced non-systemically. These adjustments are driven by the random variations in incoming till weights, which may be overfilled or underfilled, and the subsequent need to find suitable mushroom replacements that match the specific requirements of each till.

The proposed inline mushroom till weight optimization system has far-reaching implications for the packaging industry. The system has a novel approach for high-throughput and accurate packaging by weight. The system has the dual advantage of automating the current trial and error manual work (for labor savings) while obtaining higher accuracy of target package weight. Thus, the proposed machine keeps the mushroom packaging sector less dependable on the labor market while exceeding human-level weight accuracy. The high-flow electro-pneumatic end effector handles mushrooms delicately without damaging, bruising, or reducing their aesthetic appearance. The experiments showed mushroom till weight optimization yielded an improvement of 87.3% at a rate of 12 tills per minute, or 0.36 tons per hour (for 16-ounce. mushroom tills) per robot. Considering that the mushroom industry in the United States amounts to 666 pounds per year, a weight improvement of 87.3% saves mushroom packaging companies an estimated 41 million pounds annually.

The preliminary study of mushroom till data from local grocery stores suggests that 8- and 16-ounce tills are overfilled by 7.9%. These findings corroborate Quality Assurance departments at mushroom packaging houses (Juarez, 2022; Matar, 2022), which reported an average overfill rate of 7% after human intervention. Although 226.8 and 453.6 grams (8- and 16-ounce) packages have 18.1 and 19.8 grams, the 226.8 grams (8-ounce) package error rate is more pronounced as it requires higher respective accuracy. The results suggest that smaller packages tend to have a more significant error rate, possibly due to the challenging manual laborers' trial and error with smaller sets of mushrooms. Ultimately, the error rate dictates the gram-level accuracy of our system design. The error rates reported here are underestimated, considering the time taken to transport tills to grocery stores and refrigerate them. This suggests that initial errors at the mushroom packaging house are higher. However, the conclusions made here remain the same.

The experimental mushroom characterization data suggests that visual inspection gives a high-level insight into mushroom size but cannot accurately assess mushroom weight. The size-to-weight distribution is highly variable due to mushroom density and stalk sizes. The variation in mushroom density is attributed to farm conditions, which prevents vision-guided systems from solely relying on mushroom visual characteristics for optimizing mushroom till weights. The data also shows that over 3 days, mushroom loses 1.36 grams on average. The weight loss is marginal and works in the system's favor, as the overfill weight threshold can be set lower when processing the weight optimization. In turn, the weight is reflected at the retailers after transportation. To put things in perspective, the mushroom characterization study highlights that the error rate for the tills is less than the weight of one mushroom. This explains why manual labor accuracy is challenging, especially at high throughput. The workers cannot keep track of individual mushroom weights to find the best combination that satisfies the target weight.

The computer vision instance segmentation algorithm has shown mushroom set prediction with an Average Precision of 72.1 and an Average Recall of 85.23. Computer vision errors arise from mistakenly classifying sideway mushrooms as cap-up mushrooms, especially when the stalk is short. The misclassification is challenging to avoid, even for human labelers. Another source of error occurs with sideways mushrooms that have long stalks. These mushrooms tend to have an obstructed (shadowed) section between the cap and the stalk, yielding two sections for the same mushroom. Therefore, the two sections are often detected as separate masks. However, post-processing algorithms rectify this problem by determining the mushroom target from the topmost pixel of the depth map. Another source of error occurs when two mushrooms are detected as one segment. In this case, post-processing algorithms examine mushroom circularity for cap-up predictions and deprioritize non-circular mushrooms. If the two instances form a circular cluster, the error propagates through the rest of the robotic task because the middle-most pixel is chosen as a target for the robot. This is a current limitation of the automated computer vision approach. In future work, there needs to be a method to reject tills with computer vision uncertainty or other sources of error that prevent the task from fully succeeding.

The design experimentation focused on the performance of the end effector, as it is the primary interface with mushrooms and a critical component that dictates the system's success rate and throughput. The proposed approach demonstrates that the vacuum suction end effector handles mushrooms robustly from above—important as mushrooms are closely packed—irrespective of their orientation. Other end effectors, such as pneumatic finger-like grippers, handle mushrooms robustly but disrupt nearby mushrooms, and they have challenges accessing mushrooms in a pack without displacing the surrounding ones. The suction cup end effector operates at high flow rates and large pressure drops, which prevents mushroom bruising. The experiments confirmed no aesthetic changes by inspecting all mushrooms 3 days after the experiments. Furthermore, large pneumatic tubes and an air buffer tank aided the in-demand high-flow suction and blowout request. The experiment showed improved handling performance with larger suction cups, where 40 mm suction cup performance superseded irrespective of mushroom size. The improvement is due to higher suction force; suction force is dependent on the total surface area and vacuum flow rate.

The data-driven approach has shown new insights into the interplay between mushroom vacuum suctioning and robotic movement parameters. On average, the end effector performance is the highest for cap-up orientation (for all mushroom sizes), followed by stalk-up and sideways. This is due to leakage around the suction cup when manipulating mushrooms in a stalk-up or sideways orientation. On average, smaller mushrooms had a higher success rate than larger mushrooms because larger mushrooms build higher momentum that exceeds the suction force as the robot moves. In terms of robot target height, there is a slight improvement for the robot approach at −1 mm relative to the target mushroom height obtained by the depth camera. The −1 mm target height is primarily informative within the context of the experimental till setup, where a solid base supports the mushrooms from underneath, preventing them from compressing downwards. However, in production tills, mushrooms are stacked on top of each other, and due to their elastic nature, any external pressure tends to cause them to compress downwards. Consequently, a −1 mm height does not provide sufficient suction for effective mushroom handling in full-scale operations. The robotic system was adjusted to maneuver to a −5 mm target height to address this. This adjustment allowed for robust suction without disturbing surrounding mushrooms, achieving a high success rate. The experiment results benefit us by suggesting that the further down the robot moves, the more luckily the mushroom handling is successful. This deeper engagement is facilitated by the extended stroke length of the suction cup, enabling precise and gentle handling of the mushrooms. The downward movement also offsets milli-meter errors in the depth imaging. Finally, a longer suction duration above the mushroom resulted in higher rates of successful mushroom manipulation without drops. The experiment results demonstrate that 300 milli-seconds is the optimal duration that balances speed and success rate.

The robot velocity experiments have demonstrated that rapid robot movements lead to failure when handling large and medium mushrooms. This is due to their mass creating a larger moment. Thus, during the full task experimentation, a self-adjusting strategy is utilized to reduce speeds for medium and large mushrooms and speed up the robot for small mushrooms. The mushrooms are manipulated using 2000 mm/sec for small mushrooms and 4000 mm/sec for medium and large mushrooms. This strategy is unique because it is vision-informed to ensure high throughput.

To speed up the mushroom deposition away from the robot and in a controlled manner, the system utilizes blowout functionality instead of letting mushrooms free fall using gravity. The full-task experiments have shown that irrespective of the long durations needed for mushroom suction, blowing out is time-independent, and instead of long blowouts, the system utilizes two consecutive short bursts that have succeeded in a quick and reliable release. This deposition process includes small mushrooms that completely fit into the suction cup manifold. In the full-task experiments, no failures were observed due to the blowout functionality.

The system utilizes an offline queue that relies on the law of large numbers to find an optimized mushroom weight for the replacement mushroom. In the full task experimentation, the offline queue distribution slightly shifted upward during the one hundred till experiment. During the experiment, heavier mushrooms were predominantly taken from tills and replaced with lighter mushrooms. Future studies should have in-plant experiments to determine the optimal size of the offline queue (for long-term effects on the distribution) and incorporate a method to automatically and precisely alter the offline queue mushroom weight distribution.

It is essential to place the designed system and experimental results within the broader context of current research in Agaricus bisporus. Recently, there has been advances in mushroom processing such as sorting (Wang et al., 2018) and harvesting (Huang et al., 2021b, 2021c) machines. Advanced computer vision studies using deep learning algorithms for mushroom cultivation, harvesting, quality grading(Yin et al., 2022), and disease classification (Zahan et al., 2022) have been introduced. Most studies used lightweight detection algorithms such as Mask R-CNN (He et al., 2018; Yang et al., 2022) and variations of YOLO (Redmon et al., 2016; Y. Wang et al., 2022; Wei et al., 2022) for localization tasks as they are more manageable for industrial analysis. The proposed novel approach uses a set prediction strategy to avoid hand-crafted post-processing IoU thresholds, where a transformer-based instance segmentation algorithm has been applied to intensity images and depth maps to detect the precise masks of each mushroom and classify its orientation.

The proposed vision-guided robotics approach is unique in that it leverages visual information from instance segmentation to determine mushrooms' size, orientation, and location for robot targeting. This information helps determine the robot's optimal parameters to increase throughput and task success rate. The system throughput is further enhanced by synchronizing the robot with the conveyor belt, allowing for dynamic motion planning. The system's flexibility extends beyond mushrooms, showing potential for generalization to other crops in postharvest packaging and weight optimization tasks. Future studies will evaluate the system in packaging plants to assess its reliability and throughput. For widespread adoption in mushroom packaging industries, the system must demonstrate a capability for high throughput that surpasses manual labor productivity significantly.

A novel vision-guided inline robotic system has been developed to automate mushroom packaging and weight optimization. The system incorporates a high-speed delta robot, a state-of-the-art instance segmentation algorithm, and an electro-pneumatic vacuum suction system for precise mushroom handling. The weight optimization system features an online check weigher and offline weighted queue configured in the shape of a grid with known mushroom weights and fixed positions. The checkweigher measures the initial weight, and the offline queue serves as a buffer, where the robot adds, removes, or replaces mushrooms between the tills and the queue. The proposed approach digitizes a buffer queue for immediate mushroom weight measurements and a fast optimization process to find the most suitable mushroom replacement. The design utilizes an experimentally driven approach to maximize throughput and ensure weight accuracy. The system notably reduces the error rate of overfilling tills by 87.3%. This translates to 7.8 times lower error than manual packaging. The prototype system achieves a throughput of 12 tills per minute, equivalent to 0.36 tons per hour for 453.6-gram (16-ounce) tills. While tailored primarily for mushrooms, the system's design allows for minimal modifications to adapt it to optimize the packaging weights of other crops, baked goods, dairy, or any products that require precise package weight. Future enhancements will focus on increasing the system's speed, reliability, and conducting comprehensive assessments in mushroom packaging facilities.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for inline vision-guided robotics comprises:
an infeed conveyor including a line scan camera configured to capture image data and depth data;
a check weight conveyor configured to weigh a produce container in motion;
a robot configured to adapt movement speed and path in real-time based on produce size and orientation;
a processor; and
a memory, including instructions, which when executed by the processor, cause the system to:
capture image data and depth data of the produce container on the infeed conveyor;
weigh the produce container in motion on the check weight conveyor;
identify over or underweight conditions for the produce container based on the weight of the produce container;
classify produce orientation of produce in the produce container based on image data and depth data using a trained instance segmentation model based on image data and depth data;
determine target pick points based on the classification, geometric characteristics of the produce, and the depth data; and
select, using the robot, produce from or placing produce into a weighted buffer queue to meet target weights based on the over or underweight conditions of the produce container and the classified produce.

2. The system of claim 1, wherein the robot further comprises:
an end effector configured for delicate produce handling, the end effector comprising:
a suction cup with a long stroke made from food-safe, metal-detectable material;
an integrated vacuum generator; and
a solenoid-controlled pneumatic line configured to toggle between suction and blow-off modes.

3. The system of claim 1, wherein the weighted buffer queue comprises:
a grid comprising a plurality of cells, each configured to hold a single item;
a weighing system configured to measure weight changes upon placement or removal of items in the grid; and
a mapping module configured to correlate each grid cell with a known spatial coordinate.

4. The system of claim 3, wherein the instructions, when executed, further cause the system to:
store excess items not required for a current package;
track the weight of stored items individually; and
enable selection of an item from the buffer based on a desired package target weight.

5. The system of claim 1, wherein the instructions, when executed, further cause the system to:
trigger image capture based on an incremental encoder connected to a gearbox of the infeed conveyor, the encoder configured to generate a signal indicating a position of the produce container;
detect the produce container based on the captured image; and
monitor the position of the produce container based on the signal of the encoder.

6. The system of claim 1, further comprising:
a photoelectric sensor mounted between the infeed conveyor and check weight conveyor sections to generate a signal configured to ensure separation between incoming produce containers.

7. The system of claim 6, wherein the instructions, when executed, further cause the system to:
trigger, based on a signal of the photoelectric sensor, recording weighing information on the check weight conveyor.

8. The system of claim 1, wherein the line scan camera is configured to capture depth information using a projected laser line to generate a depth map.

9. The system of claim 8, wherein the depth map is obtained by measuring deformation of a laser line projected across a surface of the produce container.

10. The system of claim 1, wherein the line scan camera uses triangulation-based laser profiling.

11. A method for inline vision-guided robotics comprises:
capturing image data and depth data of a produce in a produce container on an infeed conveyor, the infeed conveyor including a line scan camera configured to capture image data and depth data;
weighing the produce container in motion on a check weight conveyor;
identifying over or underweight conditions for the produce container based on the weight of the produce container;
classifying produce orientation of the produce in the produce container based on image data and depth data using a trained instance segmentation model based on image data and depth data;
determining target pick points based on the classification, geometric characteristics of the produce, and the depth data; and
selecting, by a robot, produce from or placing produce into a static, known-weight buffer queue to meet target weights based on the over or underweight conditions of the produce container and the classified produce.

12. The method of claim 11, wherein the robot comprises:
an end effector configured for delicate produce handling, the end effector comprising:
a suction cup with a long stroke made from food-safe, metal-detectable material;
an integrated vacuum generator; and
a solenoid-controlled pneumatic line configured to toggle between suction and blow-off modes.

13. The method of claim 11, wherein the weighted buffer queue comprises:
a grid comprising a plurality of cells, each configured to hold a single item;
a weighing system configured to measure weight changes upon placement or removal of items in the grid; and
a mapping module configured to correlate each grid cell with a known spatial coordinate.

14. The method of claim 13, further comprising:
storing excess items not required for a current package;
tracking the weight of stored items individually; and
enabling selection of an item from the buffer based on a desired package target weight.

15. The method of claim 11, further comprising:
triggering image capture based on an incremental encoder connected to a gearbox of the infeed conveyor, the encoder configured to generate a signal indicating a position of the produce container;
detecting the produce container based on the captured image; and
monitoring the position of the produce container based on the signal of the encoder.

16. The method of claim 11, further comprising:
generating a signal configured to ensure separation between incoming produce containers by a photoelectric sensor mounted between the infeed conveyor and check weight conveyor sections.

17. The method of claim 16, further comprising:
triggering, based on a signal of the photoelectric sensor, recording weighing information on the check weight conveyor.

18. The method of claim 11, wherein the line scan camera uses triangulation-based laser profiling.

19. The method of claim 11, wherein the line scan camera is configured to capture depth information using a projected laser line to generate a depth map.

20. The method of claim 18, wherein the depth map is obtained by measuring deformation of a laser line projected across a surface of the produce container.
